(19) United States
(12) Patent Application Publication
(10) Pub. No.: US 2023/0099547 A1
(43) Pub. Date: Mar. 30, 2023

(54) AUTOMATED BATTERY PRECONDITIONING SYSTEM AND METHOD FOR FLEETS

(71) Applicant: Rivian IP Holdings, LLC, Irvine, CA (US)

(72) Inventors: Adam J. Mandel-Senft, San Leandro, CA (US); Marinus Jacobus Adrianus Kerstens, Los Gatos, CA (US); Tyler Erikson, Torrance, CA (US)

(21) Appl. No.: 17/896,346

(22) Filed: Aug. 26, 2022

Related U.S. Application Data
(60) Provisional application No. 63/248,782, filed on Sep. 27, 2021.

(51) Int. Cl. H02J 7/00; H01M 10/42; B60L 53/63

(52) U.S. Cl. CPC H02J 7/00036; H02J 7/0013; H02J 7/0048; H02J 7/0069; H01M 10/4257; B60L 53/63; H02J 7/0071; H01M 2010/4278; H01M 2010/4271; H01M 2220/20

(57) ABSTRACT

An automated vehicle battery preconditioning system and method that receive battery state-of-charge and battery preconditioning time information from a vehicle battery management system of each of a plurality of vehicles and battery charging time and charging power information from a battery charger management system and, based on the information, generate a battery charging schedule and a battery preconditioning schedule for the plurality of vehicles; direct the battery charger management system to charge a battery of each of the plurality of vehicles according to the battery charging schedule; and direct the vehicle battery management system of each of the plurality of vehicles to precondition the associated battery according to the battery preconditioning schedule. The vehicle battery preconditioning system and method further receive power grid schedule and cost information and, based on the information, generate the battery charging schedule and the battery preconditioning schedule for the plurality of vehicles.

### CROSS-REFERENCE TO RELATED APPLICATION

The present disclosure claims the benefit of priority of co-pending U.S. Provisional Patent Application No. 63/248,782, filed on Sep. 27, 2021, and entitled “AUTOMATED BATTERY PRECONDITIONING SYSTEM AND METHOD FOR FLEETS,” the contents of which are incorporated in full by reference herein.

### INTRODUCTION

The present disclosure relates generally to the automotive and electric vehicle (EV), hybrid electric vehicle (HEV), and fleet charging fields. More particularly, the present disclosure relates to a vehicle battery preconditioning system and automated method for conducting delayed or sequential charging sessions, such as in a fleet application.

### SUMMARY

For the high power charging of EVs, HEVs, and associated energy storage systems, it is important that a battery is at the appropriate temperature for optimal charging, and it may be desirable to charge during charging windows when power is cheaper on the grid utilized, and when the grid is less sensitive to usage spikes, such a late and night and early in the morning. These considerations raise numerous challenges, especially in the fleet charging context.

The present background and summary are provided as illustrative environmental context only, and should not be considered to be limiting in any manner. It will be readily apparent to those of ordinary skill in the art that the concepts and principles of the present disclosure may be applied in other environmental contexts equally.

The present disclosure provides a vehicle battery preconditioning system and automated method for conducting delayed or sequential charging sessions, such as in a fleet application. This method, in a centralized and coordinated manner, gathers state-of-charge (SOC), environmental (e.g., battery temperature), battery health, and preconditioning information from one or more vehicles and orchestrates the subsequent preconditioning and charging of the one or more vehicles. In a fleet vehicle context, this system and method can be used to optimize the sequencing and charging of multiple vehicles connected to a charging system, taking individual vehicle preconditioning needs and times into account, as well as preferred charging windows. The system and method can direct various vehicles connected, or to be connected, for charging when to begin their battery preconditioning operations, based on reported conditions, and, subsequently, when to begin charging.

For example, the system and method of the present disclosure, implemented in fleet management software residing at a charging facility or a fleet management application residing in the cloud, may direct each of a plurality of vehicles connected, or to be connected, to a charging system when to begin their preconditioning operations, based on reported conditions, and, subsequently, when to begin charging, such that an optimized SOC is achieved for each vehicle in the fleet based on expected route usage for a given time period, as well as minimized charging electricity cost and/or electrical grid impact. Thus, fleet vehicle charging operations may be orchestrated and coordinated based on energy cost/usage considerations, weather shocks, and the like. It will be readily apparent to those of ordinary skill in the art that the concepts and principles of the present disclosure may be implemented in other contexts comparable to the vehicle fleet management context as well. It should be understood that the system and method of the present disclosure may be used to charge battery systems while disconnected from vehicles, such as when swappable battery units are utilized, without limitation.

In one illustrative embodiment, the present disclosure provides a vehicle battery preconditioning system, including: memory storing instructions executed by a processor to receive battery state-of-charge and battery preconditioning time information from a vehicle battery management system of each of a plurality of vehicles coupled to, or to be coupled to, a battery charging system and battery charging time and charging power information from a battery charger management system of the battery charging system and, using the information, generate a battery charging schedule and a battery preconditioning schedule for the plurality of vehicles; direct the battery charger management system to charge a battery of each of the plurality of vehicles according to the battery charging schedule; and direct the vehicle battery management system of each of the plurality of vehicles to precondition the associated battery according to the battery preconditioning schedule. The vehicle battery preconditioning system further includes memory storing instructions executed by the processor to receive electrical grid schedule and cost information and, using the information, generate the battery charging schedule and the battery preconditioning schedule for the plurality of vehicles to minimize electricity cost and/or impact on the electrical grid.

In another illustrative embodiment, the present disclosure provides a vehicle battery preconditioning method, including: receiving battery state-of-charge and battery preconditioning time information from a vehicle battery management system of each of a plurality of vehicles coupled to, or to be coupled to, a battery charging system and battery charging time and charging power information from a battery charger management system of the battery charging system and, using the information, generating a battery charging schedule and a battery preconditioning schedule for the plurality of vehicles; directing the battery charger management system to charge a battery of each of the plurality of vehicles according to the battery charging schedule; and directing the vehicle battery management system of each of the plurality of vehicles to precondition the associated battery according to the battery preconditioning schedule. The vehicle battery preconditioning method further includes receiving electrical grid schedule and cost information and, using the information, generating the battery charging schedule and the battery preconditioning schedule for the plurality of vehicles to minimize electricity cost and/or impact on the electrical grid.

In a further illustrative embodiment, the present disclosure provides a non-transitory computer-readable medium including memory storing vehicle battery preconditioning instructions executed by a processor to carry out the steps, including: receiving battery state-of-charge and battery preconditioning time information from a vehicle battery management system of each of a plurality of vehicles coupled to, or to be coupled to, a battery charging system and battery charging time and charging power information from a battery charger management system of the battery charging system and, using the information, generating a battery charging schedule and a battery preconditioning schedule for the plurality of vehicles; directing the battery charger management system to charge a battery of each of the plurality of vehicles according to the battery charging schedule; and directing the vehicle battery management system of each of the plurality of vehicles to precondition the associated battery according to the battery preconditioning schedule. The steps further include receiving electrical grid schedule and cost information and, using the information, generating the battery charging schedule and the battery preconditioning schedule for the plurality of vehicles to minimize electricity cost and/or impact on the electrical grid.

### BRIEF DESCRIPTION OF THE DRAWINGS

The present disclosure is illustrated and described with reference to the various drawings, in which like reference numbers are used to denote like system components/method steps, as appropriate, and in which:

FIG. 1 is a schematic diagram of one illustrative embodiment of the vehicle battery preconditioning system of the present disclosure;

FIG. 2 is a schematic diagram illustrating a plurality of vehicles coupled to a daisy-chain (or parallel) charger system utilizing the vehicle battery preconditioning system of FIG. 1;

FIG. 3 is a schematic diagram of one illustrative embodiment of the vehicle battery preconditioning and charging method of the present disclosure;

FIG. 4 is a network diagram of a cloud-based system for implementing the various systems and methods of the present disclosure;

FIG. 5 is a block diagram of a server/processing system that may be used in the cloud-based system of FIG. 4 or stand-alone; and

FIG. 6 is a block diagram of a remote device that may be used in the cloud-based system of FIG. 4 or stand-alone.

### DETAILED DESCRIPTION

As alluded to herein above, to charge an EV or HEV, or, more broadly, any energy storage system, such as a home energy storage system or the like, the battery of each unit must be at an appropriate temperature to adequately accept power from the charger. This is especially relevant for high power charging; in these cases, the battery of each unit must be meaningfully conditioned (i.e., heated or cooled) in order to adequately accept the charge. Depending on the ambient temperature and the existing state of the battery, this conditioning can take an extended period of time, resulting in an extended charging session overall. Typically, the conditioning part of a charging session begins once the vehicle and charger begin the communications handshake, whether or not the vehicle is physically/electrically connected to the charger. In these cases, the charger and vehicle calibrate the battery's condition with the available power from the charger. When the vehicle's battery is too hot or cold, only low power (i.e., slower) charging can occur when connected. During this low power charging, the battery is heated or cooled to the optimal temperature so that it can accept full power for the fastest charging.

The conditioning step thus extends the charging session by not allowing the vehicle to charge at its full power immediately. These longer charging sessions can be a significant issue for commercial fleet vehicles that require high uptime and low downtime to accomplish their objectives. The system and method of the present disclosure eliminate the additional time impact of this battery conditioning by having the charging software communicate with the vehicles, as well as fleet management software, to facilitate preconditioning of the battery before the charging session begins, before or after the vehicles are connected to the charger.

In many commercial fleet vehicle applications, the vehicle is likely to be parked and plugged into the charger when not in use, but set to not start charging immediately. Two examples of this, which could be implemented at the same facility, are:
1. The chargers at the depot for these commercial fleet vehicles are designed to charge multiple vehicles sequentially. These chargers, like a direct current (DC) daisy-chain charger or the like, have many vehicles plugged in, but only one, or a few, can charge at a time. After the charger has completed charging one vehicle, it moves to the next vehicle in the sequence. With these types of chargers, the later vehicles in the sequence do not start charging immediately.
2. The facility where these vehicles charge utilizes an energy load management system that reduces the electricity use during the most expensive times of the day and/or when energy spikes are a problem globally. The vehicle might return to the depot and be plugged into the charger during an expensive use period or when the grid might be taxed, but not need to be available until later. The charger would delay the charging session until the high cost energy or spike period has passed.

In both of these examples, charging is initially delayed, but, once the session begins, it is beneficial for it to be completed as quickly as possible so that a vehicle can be put back into fleet operation. Preconditioning the battery before the charging session begins allows for the most efficient charging time in the aggregate, increasing overall vehicle uptime/availability. This technology allows the vehicles to have a shorter effective charging time without any additional hardware required. For this battery preconditioning to be automated in a large commercial vehicle charging depot, each vehicle, the charger, the overall fleet management system, and the corresponding software exchange location, ambient temperature, if the vehicle is plugged into the charger, position in the charging queue (for sequential charging), battery SOC, battery temperature, battery health, preconditioning requirements, route demands, dispatch schedule, and the like, without limitation. The system and method are connected to the facility's energy optimization algorithm and designed to calculate the battery preconditioning start time and begin this process during the optimal times. This includes during the low cost time-of-use (TOU) electricity window and/or when the adjacent facility is using minimal power to limit demand/power fees, as well as to improve electrical grid stability by avoiding demand spikes. This allows the vehicle to maximize the energy consumed in the most efficient way, such as with low cost and/or promoting grid stability. The system and method ensure the quickest charging for the vehicles since the charging sessions will not be extended by low power charging during battery conditioning and applies to alternating current (AC) and direct current (DC) charging.

The problem highlighted in the present disclosure has been addressed for consumer vehicles to only a limited extent. For example, when a driver inputs certain chargers into their navigation system, the vehicle knows to precondition the battery before arriving at the charging station. However, this only occurs when the charger is entered explicitly into the navigation system and as the vehicle's next destination. However, no automation or coordination has been provided for commercial fleets, without individualized planning. The process of the present disclosure does not require any regular human input to indicate when a charging session will begin or that the vehicle is expected to charge in the near future. The preconditioning of the solution of the present disclosure is based on the charger's hardware configuration and the fleet's energy management schedule. This solution is the most practical application of preconditioning for large fleets of EVs or HEVs because of the communication between the vehicle, charger, and overall fleet management software that automates the process. The solution of the present disclosure is based on a cloud connected vehicle automatically optimizing charging and not necessarily any driver input into the vehicle.

The automated process of the present disclosure increases vehicle uptime through optimized charging; battery preconditioning minimizing the time needed to charge. This is valuable to commercial fleets. This also positively impacts the life of the battery. Due to the preconditioning, the battery is not at risk to experience the more severe impacts of high power charging early in a charging session when the temperature is still being optimized. By the time the power reaches the battery, there is minimal impact, since the battery is fully ready to receive it. This can have a positive equipment impact across a large fleet.

This solution of the present disclosure tightly integrates vehicle, charger, and fleet management hardware and software, exchanging the required vehicle/charger data and then facilitating the vehicle to take the directed preconditioning actions. The solution of the present disclosure is not limited to the vehicle context described, but may be applied more broadly to any energy storage system context, such as home power systems and the like.

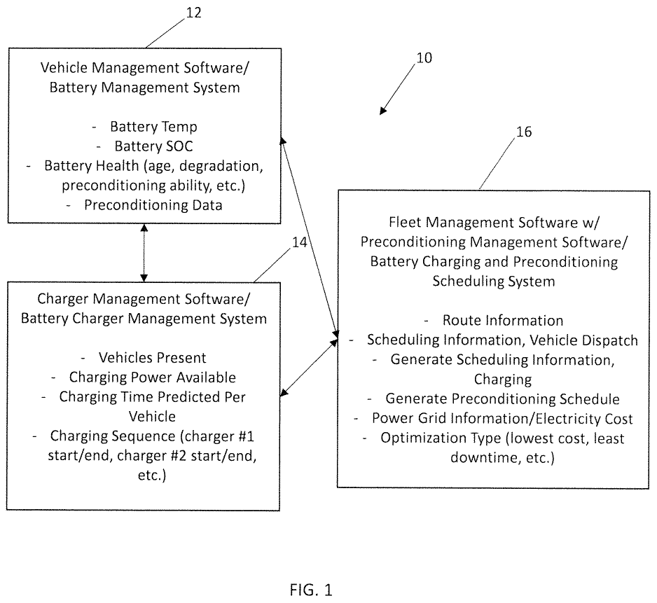

Referring now specifically to FIG. 1, in one illustrative embodiment, the vehicle battery preconditioning system 10 (more generically, the battery preconditioning system 10) includes vehicle management software 12 (more generically, a battery management system 12) in communication with charger management software 14 (more generically, a battery charger management system 14) in communication with fleet management software 16 (more generically, a battery charging and preconditioning scheduling system 16), here including robust preconditioning management software in accordance with the present disclosure. These software modules are all connected via wired or wireless communications links, such that information and coordinated instructions may be shared. The vehicle management software 12 is operable for providing battery information, such as battery temperature, SOC, health, and preconditioning parameters and times, among other information. The charger management software 14 is operable for monitoring vehicles present/connected and available charging power and time information, among other information. The fleet management software 16 is operable for providing route information and scheduling information, power grid information, and charging optimization information, among other information, and, here, establishing a preconditioning schedule when multiple vehicles are coupled to, or to be coupled to, a charging facility based on all the provided information, including power grid cost, time, and availability information. External information, such as charging facility layout, weather information, and the like, may also be utilized by the various modules.

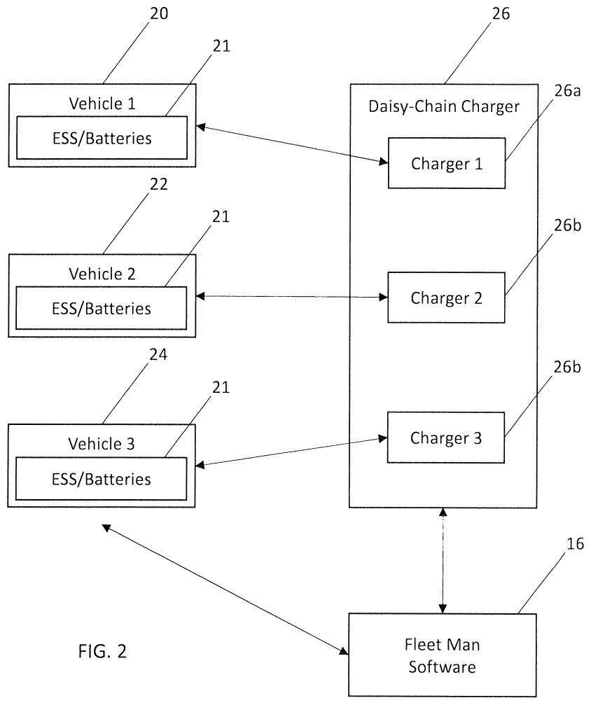

FIG. 2 is a schematic diagram illustrating a plurality of vehicles, including vehicle 1 20, vehicle 2 22, and vehicle 3 24, coupled to a daisy-chain charger system 26 (including charger 1 26a, charger 2 26b, and charger 3 26c) utilizing the vehicle battery preconditioning system 16 of FIG. 1. Each vehicle 20, 22, and 24 utilizes and energy storage system (ESS) including one or more batteries 21. These ESSs/batteries 21 may be charged while in the vehicles 20, 22, and 24 or while disconnected from the vehicles 20, 22, and 24, such as when swappable battery units are utilized. The charger system 26 may utilize multiple charging stations coupled to a common power source and centralized charging logistics, for example. In this scenario, charging is performed in sequence. Here, vehicle 1 20 begins charging when connected, although the process may start with no vehicles charging. Based on available power and charging time calculations given SOC and the like, the charger management software 14 (FIG. 1) calculates when charging may begin for vehicle 2 22 and vehicle 3 24, and so on. For example, if vehicle 1 20 is currently charging, vehicle 2 22 may begin charging in 45 mins and vehicle 3 24 may begin charging in 1 hr and 30 mins, absent other considerations. The charger management software 14 notifies the vehicle management software 12 (FIG. 1) of this expected charging schedule, as well as the available charger power (100 kW, for example). The vehicle management software 12 then evaluates the status of the battery for each vehicle, including SOC and temperature. For example, the vehicle management software 12 for vehicle 2 22 may determine that the battery's SOC is 30% and that 100 kW can be accepted, and that the battery has a temperature that is low for optimal charging so that only 20 kW can initially be accepted before the proper battery condition is reached to utilize the full 100 kW available. Each vehicle 20, 22, and 24 may make a similar determination.

At this stage, the vehicle management software 12 pairs this vehicle data with the projected charging time and power information to determine the needed battery preconditioning for quickest charging. This algorithm then assigns an amount of time required for preconditioning for each vehicle. For example, vehicle 2 22 may determine that 20 mins of preconditioning are needed to heat the battery to accept the full 100 kW charging power and provide the shortest possible charging session. At the direction of the fleet management software 16, which is coordinating fleet preconditioning, the vehicle management software 12 is directed to begin preconditioning each battery at the appropriate time before the associated charging session is expected to begin. For example, the vehicle management software 12 is directed to begin preconditioning the battery of vehicle 2 22 in 25 mins, 20 mins before the start of the expected charging session in 45 mins. All cases are managed in this manner.

Thus, each coordinated charging session begins as planned with each vehicle battery already preconditioned for optimal charging, until the charging session is complete. As viewed in the abstract, this allows the charging of multiple fleet vehicles to be coordinated in terms of charging needs given SOC and expected duty cycle and charger power, all while arranging for the preconditioning of all vehicle batteries so that charging can be optimized in terms of time. Cost is accounted for by utilizing knowledge of power grid windows and preferred charging times; minimizing grid demand spikes as well. For example, the present methodology could be used to optimally charge a fleet of electric emergency vehicles in a remaining time window before a power grid is compromised by an incoming storm, a fire, or the like. It should be noted that battery preconditioning may be performed using vehicle energy sources and/or outside energy sources, such as when the vehicle is parked in a charging bay that may have external heaters/coolers. The precise manner of preconditioning is not the focus of the present disclosure.

Thus, the present disclosure provides a vehicle battery preconditioning system and method to automate the preconditioning process, including for delayed or sequential fleet charging that, in a centralized and coordinated manner, gathers SOC, environmental (e.g., battery temperature), and preconditioning information from one or more vehicles and orchestrates the subsequent preconditioning and charging of the one or more vehicles. In a fleet vehicle context, this system and method can be used to optimize the sequencing and charging of multiple vehicles connected to a charging system, taking individual vehicle preconditioning needs and times into account, as well as preferred charging windows. The system and method can direct various vehicles connected, or to be connected, for charging when to begin their preconditioning operations, based on reported conditions, and, subsequently, when to begin charging.

For example, the system and method of the present disclosure, implemented in local fleet management software or a fleet management application residing in the cloud, may direct each of a plurality of vehicles connected, or to be connected, to a charging system when to begin their preconditioning operations, based on reported conditions, and, subsequently, when to begin charging, such that an optimized SOC is achieved for each vehicle in the fleet based on expected route or duty cycle usage for a given time period, as well as minimized charging grid cost and/or impact. Thus, fleet vehicle charging operations may be orchestrated and coordinated based on energy cost/usage considerations, electrical grid stability, weather shocks, and the like.

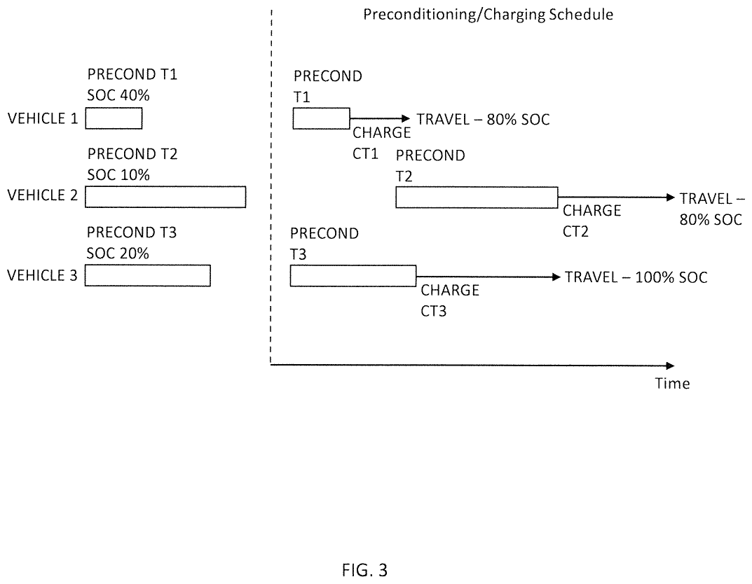

FIG. 3 illustrates an example preconditioning and charging schedule established using the battery preconditioning system 10 of FIG. 1. Here, vehicle 1 reports a preconditioning time of T1 under present conditions and a SOC of 40%, vehicle 2 reports a preconditioning time of T2 under present conditions and a SOC of 10%, and vehicle 3 reports a preconditioning time of T3 under present conditions and a SOC of 20%. Once all three vehicles are communicatively and/or physically/electrically coupled to the daisy-chain charging system, the preconditioning/charging schedule directs vehicle 1 to immediately precondition for T1 and then immediately start charging for CT1 to a SOC of 80% before beginning travel. This 80% SOC is determined to be sufficient for the subsequent expected use of vehicle 1. The preconditioning/charging schedule also directs vehicle 3 to immediately precondition for T3 and start charging for CT3 to a SOC of 100% after vehicle 1 completes charging before beginning travel. This 100% SOC is determined to be necessary for the subsequent expected use of vehicle 3. The preconditioning/charging schedule further directs vehicle 2 to wait a predetermined period of time and only then precondition for T2 and start charging for CT2 to a SOC of 80% after vehicle 3 completes charging before beginning travel. This 80% SOC is determined to be sufficient for the subsequent expected use of vehicle 2. Thus, based on reported battery SOC, battery health, and reported expected preconditioning times at present conditions, the battery preconditioning system 10 determines order and timing for the various vehicles coupled to a charging system to precondition, charge, and subsequently travel, based on available charging capacity, known route demands, etc. As provided herein above, grid cost/stability considerations may also be used to refine this scheduling function.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially. It should be noted that the algorithms of the present disclosure may be implemented on an embedded processing system running a real time operating system (OS), which provides an assured degree of availability and low latency. As discussed below, processing in a cloud system may also be implemented if such availability and latency problems are addressed.

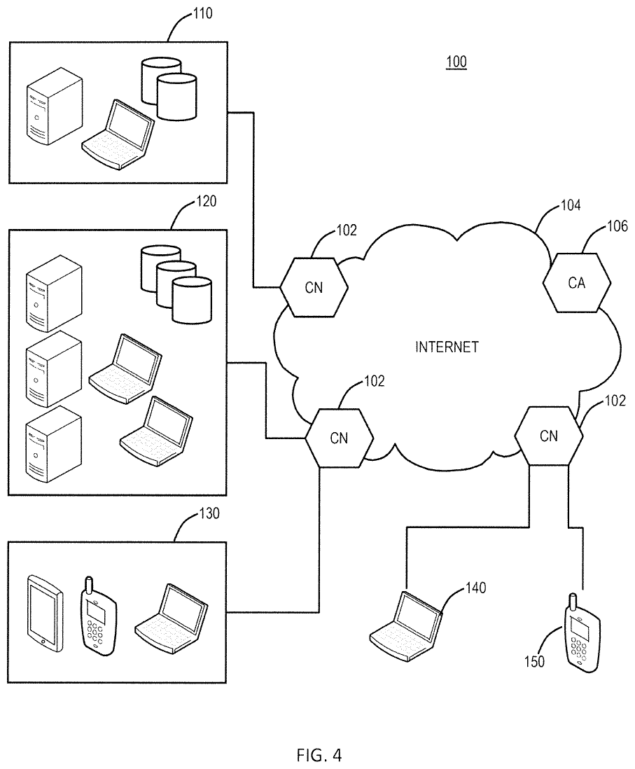

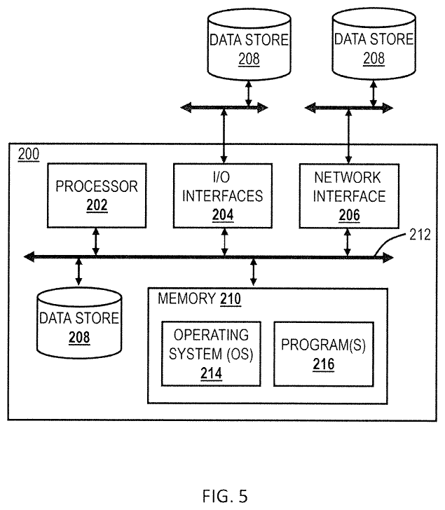

FIG. 4 is a network diagram of a cloud-based system 100 for implementing various cloud-based services of the present disclosure, where applicable. The cloud-based system 100 includes one or more cloud nodes (CNs) 102 communicatively coupled to the Internet 104 or the like. The cloud nodes 102 may be implemented as a server or other processing system 200 (as illustrated in FIG. 5) or the like and can be geographically diverse from one another, such as located at various data centers around the country or globe. Further, the cloud-based system 100 can include one or more central authority (CA) nodes 106, which similarly can be implemented as the server 200 and be connected to the CNs 102. For illustration purposes, the cloud-based system 100 can connect to a regional office 110, headquarters 120, various individual's homes 130, laptops/desktops 140, and mobile devices 150, each of which can be communicatively coupled to one of the CNs 102. These locations 110, 120, and 130, and devices 140 and 150 are shown for illustrative purposes, and those skilled in the art will recognize there are various access scenarios to the cloud-based system 100, all of which are contemplated herein. The devices 140 and 150 can be so-called road warriors, i.e., users off-site, on-the-road, etc. The cloud-based system 100 can be a private cloud, a public cloud, a combination of a private cloud and a public cloud (hybrid cloud), or the like.

Again, the cloud-based system 100 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 110, 120, and 130 and devices 140 and 150. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” is sometimes used to describe application programs offered through cloud computing. A common shorthand for a provided cloud computing service (or even an aggregation of all existing cloud services) is “the cloud.” The cloud-based system 100 is illustrated herein as one example embodiment of a cloud-based system, and those of ordinary skill in the art will recognize the systems and methods described herein are not necessarily limited thereby.

FIG. 5 is a block diagram of a server or other processing system 200, which may be used in the cloud-based system 100 (FIG. 4), in other systems, or stand-alone, such as in the vehicle itself. For example, the CNs 102 (FIG. 4) and the central authority nodes 106 (FIG. 4) may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 5 depicts the server or other processing system 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but is not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104 (FIG. 4). The network interface 206 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., a SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed herein. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

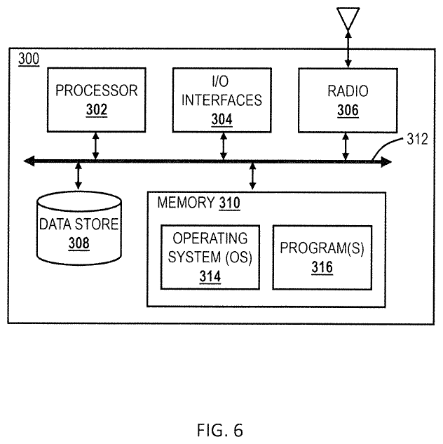

FIG. 6 is a block diagram of a user device 300, which may be used in the cloud-based system 100 (FIG. 4), as part of a network, or stand-alone. The user device 300 can be a vehicle, a smartphone, a tablet, a smartwatch, an Internet of Things (IoT) device, a laptop, a virtual reality (VR) headset, etc. The user device 300 can be a digital device that, in terms of hardware architecture, generally includes a processor 302, I/O interfaces 304, a radio 306, a data store 308, and memory 310. It should be appreciated by those of ordinary skill in the art that FIG. 6 depicts the user device 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 can be, for example, but is not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 306 enables wireless communication to an external access device or network. Any number of suitable wireless data communication protocols, techniques, or methodologies can be supported by the radio 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

Again, the memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 6, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network, such as the cloud-based system 100 (FIG. 4).

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A system, comprising:
memory storing instructions executed by a processor to:
determine state-of-charge and preconditioning time information from a battery management system of each of a plurality of energy storage systems and charging time and charging power information from a battery charger management system;
generate a charging schedule and a preconditioning schedule for the plurality of energy storage systems based on the determined state-of-charge and preconditioning time information and the charging time and charging power information;
direct the battery management system of each of the plurality of energy storage systems to precondition the associated battery according to the preconditioning schedule; and
direct the battery charger management system to charge a battery of each of the plurality of energy storage systems according to the charging schedule.

2. The system of claim 1, further comprising memory storing instructions executed by the processor to determine power grid schedule and cost information and, based on the power grid schedule and cost information, generate the charging schedule and the preconditioning schedule for the plurality of energy storage systems.

3. The system of claim 1, further comprising memory storing instructions executed by the processor to determine power grid demand information and, based on the power grid demand information, generate the charging schedule and the preconditioning schedule for the plurality of energy storage systems.

4. The system of claim 1, further comprising memory storing instructions executed by the processor to determine information related to a time window related to an impending power disruption event and, based on the information related to the time window related to the impending power disruption event, generate the charging schedule and the preconditioning schedule for the plurality of energy storage systems.

5. The system of claim 1, wherein the state-of-charge and preconditioning time information is determined from the battery management system of each of the plurality of energy storage systems via a wireless communication connection prior to each of the plurality of energy storage systems being physically/electrically connected to a charger system associated with the battery charger management system.

6. The system of claim 1, wherein the state-of-charge and preconditioning time information is determined from the battery management system of each of the plurality of energy storage systems via a wired communication connection subsequent to each of the plurality of energy storage systems being physically/electrically connected to a charger system associated with the battery charger management system.

7. The system of claim 1, further comprising memory storing instructions executed by the processor to send a notification to at least one of the plurality of energy storage systems, wherein the notification comprises an indication of the charging schedule and the preconditioning schedule.

8. A method, comprising:
determining state-of-charge and preconditioning time information from a battery management system of each of a plurality of vehicles coupled to a charging system and charging time and charging power information from a battery charger management system of the charging system and, based on the state-of-charge and preconditioning time information and the charging time and charging power information, generating a charging schedule and a preconditioning schedule for the plurality of vehicles;
directing the battery management system of each of the plurality of vehicles to precondition the associated battery according to the preconditioning schedule; and
directing the battery charger management system to charge a battery of each of the plurality of vehicles according to the charging schedule.

9. The method of claim 8, further comprising determining power grid schedule and cost information and, based on the power grid schedule and cost information, generating the charging schedule and the preconditioning schedule for the plurality of vehicles.

10. The method of claim 8, further comprising determining power grid demand information and, based on the power grid demand information, generating the charging schedule and the preconditioning schedule for the plurality of energy storage systems.

11. The method of claim 8, further comprising determining information related to a time window related to an impending power disruption event and, based on the information related to the time window related to the impending power disruption event, generating the charging schedule and the preconditioning schedule for the plurality of energy storage systems.

12. The method of claim 8, wherein the state-of-charge and preconditioning time information is determined from the battery management system of each of the plurality of vehicles via a wireless communication connection prior to each of the plurality of vehicles being physically/electrically connected to a charger system associated with the battery charger management system.

13. The method of claim 8, wherein the state-of-charge and preconditioning time information is determined from the battery management system of each of the plurality of vehicles via a wired communication connection subsequent to each of the plurality of vehicles being physically/electrically connected to a charger system associated with the battery charger management system.

14. The method of claim 8, further comprising sending a notification to at least one of the plurality of vehicles, wherein the notification comprises an indication of the charging schedule and the preconditioning schedule.

15. A non-transitory computer-readable medium comprising memory storing instructions executed by a processor to carry out the steps comprising:
determining state-of-charge and preconditioning time information from a battery management system of each of a plurality of vehicles coupled to a charging system and charging time and charging power information from a battery charger management system of the charging system and, based on the state-of-charge and preconditioning time information and the charging time and charging power information, generating a charging schedule and a preconditioning schedule for the plurality of vehicles;
directing the battery management system of each of the plurality of vehicles to precondition the associated battery according to the preconditioning schedule;
directing the battery charger management system to charge a battery of each of the plurality of vehicles according to the charging schedule.

16. The non-transitory computer-readable medium of claim 15, the steps further comprising determining power grid schedule and cost information and, based on the power grid schedule and cost information, generating the charging schedule and the preconditioning schedule for the plurality of vehicles.

17. The non-transitory computer-readable medium of claim 15, the steps further comprising determining power grid demand information and, based on the power grid demand information, generating the charging schedule and the preconditioning schedule for the plurality of energy storage systems.

18. The non-transitory computer-readable medium of claim 15, the steps further comprising determining information related to a time window related to an impending power disruption event and, based on the information related to the time window related to the impending power disruption event, generating the charging schedule and the preconditioning schedule for the plurality of energy storage systems.

19. The non-transitory computer-readable medium of claim 15, wherein the state-of-charge and preconditioning time information is determined from the battery management system of each of the plurality of vehicles via a wireless communication connection prior to each of the plurality of vehicles being physically/electrically connected to a charger system associated with the battery charger management system.

20. The non-transitory computer-readable medium of claim 15, wherein the state-of-charge and preconditioning time information is determined from the battery management system of each of the plurality of vehicles via a wired communication connection subsequent to each of the plurality of vehicles being physically/electrically connected to a charger system associated with the battery charger management system.
